(19) United States
(12) Patent Application Publication
(10) Pub. No.: US 2025/0142544 A1
(43) Pub. Date: May 1, 2025

(54) ELECTRONIC DEVICE FOR ADJUSTING BANDWIDTH BASED ON DATA TRAFFIC AND OPERATION METHOD OF ELECTRONIC DEVICE

(71) Applicant: SAMSUNG ELECTRONICS CO., LTD., Suwon-si (KR)

(72) Inventors: Hyeonu CHOI, Suwon-si (KR); Hyunkee MIN, Suwon-si (KR); Wonbin PARK, Suwon-si (KR); Junsu CHOI, Suwon-si (KR); Jeongyong MYOUNG, Suwon-si (KR); Sungbin MIN, Suwon-si (KR); Mincheol JEONG, Suwon-si (KR); Sunggi CHOI, Suwon-si (KR)

(21) Appl. No.: 18/949,774

(22) Filed: Nov. 15, 2024

Related U.S. Application Data
(63) Continuation of application No. PCT/KR2024/016093, filed on Oct. 22, 2024.

(30) Foreign Application Priority Data
Oct. 27, 2023 (KR) 10-2023-0145892
Dec. 6, 2023 (KR) 10-2023-0175957

(51) Int. Cl. H04W 72/0453; H04W 28/02; H04W 84/12

(52) U.S. Cl. CPC H04W 72/0453; H04W 28/0221; H04W 84/12

(57) ABSTRACT

An electronic device may include: a communication circuit connected to a first external electronic device; a processor; and a memory, wherein the memory is configured to store instructions that cause the electronic device to identify a bandwidth of a first link between the electronic device and the first external electronic device and a bandwidth of a second link established between the electronic device and a second external electronic device, when a size of the bandwidth of the second link is larger than a size of the bandwidth of the first link, identify traffic of data transmitted and/or received by the second external electronic device, control the communication circuit to transmit information indicating a size of a reduced bandwidth of the second link to the second external electronic device, and when the second external electronic device has reduced the bandwidth of the second link, reduce the bandwidth of the second link.

### CROSS-REFERENCE TO RELATED APPLICATIONS

This application is a continuation application of International Application No. PCT/KR2024/016093 designating the United States, filed on Oct. 22, 2024, in the Korean Intellectual Property Office and claiming priority to Korean Patent Application No. 10-2023-0145892, filed on Oct. 27, 2023, in the Korean Intellectual Property Office and Korean Patent Application Number 10-2023-0175957, filed on Dec. 6, 2023, in the Korean Intellectual Property Office. The disclosures of each of these applications are incorporated by reference herein in their entireties.

### TECHNICAL FIELD

Various embodiments of the disclosure relate to an electronic device and an operation method thereof, and to a technology for adjusting a bandwidth based on data traffic.

### BACKGROUND

With the supply of various electronic devices increasing, the speed of wireless communication available to various electronic devices has been improved. Among wireless communication standards supported by recent electronic devices, IEEE 802.11 WLAN (or Wi-Fi) refers to a standard for implementing high-speed wireless connection between various electronic devices. Initially implemented Wi-Fi may support a maximum transmission speed of 1 to 9 Mbps, but Wi-Fi 6 technology (or IEEE 802.11ax) may support a maximum of transmission speed of about 10 Gbps.

Via wireless communication that supports a high transmission speed, an electronic device may support various services (for example, a Ultra High Definition (UHD)-quality video streaming service, an augmented reality (AR) service, a virtual reality (VR) service, and/or a mixed reality (MR) service) using data having a relatively large capacity, as well as various other services.

The electronic device may provide a mobile hotspot function which is a function that enables an external electronic device connected, for example, via short-range wireless communication to perform a connection to a data network through the electronic device. When it is difficult or impossible to connect to the data network by the external electronic device alone, the external electronic device may receive data transmitted by the data network or transmit data to the data network through the electronic device, and thus perform a service using the data network.

### DISCLOSURE

An electronic device may, when the electronic device has activated a function that enables an external electronic device connected, for example, via short-range wireless communication to perform a connection to a data network through the electronic device, receive data through a link established between the electronic device and another external electronic device configured to provide a connection to the data network, and transmit the received data through a link established between the electronic device and the external electronic device.

However, a bandwidth of the link established between the electronic device and the another external electronic device may be smaller than a bandwidth of the link established between the electronic device and the external electronic device, and the external electronic device may wait to transmit and/or receive data while the electronic device receives the data through the another external electronic device.

The longer the external electronic device waits to transmit and/or receive data, the more standby power a communication circuit of the external electronic device consumes.

The technical tasks to be achieved herein may not be limited to the above-mentioned technical tasks, and other technical tasks not mentioned may be clearly understood, through the following descriptions, by those skilled in the art to which the disclosure belongs.

An electronic device according to an embodiment may include a communication circuit connected to a first external electronic device configured to provide a connection to a data network. The electronic device may include a processor. The electronic device may include a memory. The memory may be configured to store instructions that, when executed by the processor, cause the electronic device to identify a bandwidth of a first link established between the electronic device and the first external electronic device and a bandwidth of a second link established between the electronic device and a second external electronic device configured to transmit and/or receive data to the data network through the electronic device. The memory may be configured to store instructions that, when executed by the processor, cause the electronic device to, in a case that a size of the bandwidth of the second link is larger than a size of the bandwidth of the first link, identify traffic of data transmitted and/or received by the second external electronic device. The memory may be configured to store instructions that, when executed by the processor, cause the electronic device to, in a case that the traffic satisfies a designated condition, control the communication circuit to transmit information indicating a size of a reduced bandwidth of the second link to the second external electronic device. The memory may be configured to store instructions that, when executed by the processor, cause the electronic device to, in a case that the second external electronic device has reduced the bandwidth of the second link, reduce the bandwidth of the second link.

An operation method of an electronic device according to an embodiment may include identifying a bandwidth of a first link established between the electronic device and a first external electronic device configured to provide a connection to a data network and a bandwidth of a second link established between the electronic device and a second external electronic device configured to transmit and/or receive data to the data network through the electronic device. The operation method of the electronic device may include, in a case that a size of the bandwidth of the second link is larger than a size of the bandwidth of the first link, identifying traffic of data transmitted and/or received by the second external electronic device. The operation method of the electronic device may include, in a case that the traffic satisfies a designated condition, transmitting information indicating a size of a reduced bandwidth of the second link to the second external electronic device. The operation method of the electronic device may include, in a case that the second external electronic device has reduced the bandwidth of the second link, reducing the bandwidth of the second link.

### ADVANTAGEOUS EFFECTS

According to an electronic device and an operation method of the electronic device according to an embodiment, in a case that a bandwidth of a first link established between the electronic device and a first external electronic device configured to provide a connection to a data network is smaller than a bandwidth of a second link established between the electronic device and a second external electronic device configured to transmit and/or receive data to the data network through the electronic device, the electronic device may identify traffic of data transmitted and/or received by the second external electronic device. The electronic device may, in a case that the traffic of the data satisfies a designated condition, transmit information indicating a reduced bandwidth of the second link to the second external electronic device, and cause the second external electronic device to reduce the bandwidth of the second link. The electronic device may reduce the bandwidth of the second link, so as to reduce power consumed by the second external electronic device.

The effects obtainable from the disclosure are not limited to the above-mentioned effects, and other effects not mentioned may be clearly understood, through the following descriptions, by those skilled in the art to which the disclosure belongs.

### BRIEF DESCRIPTION OF DRAWINGS

FIG. 1 is a block diagram of an electronic device according to various embodiments of the disclosure;

FIG. 2A is a diagram illustrating an electronic device, a first external electronic device, and a second external electronic device according to an example;

FIG. 2B is a diagram illustrating that a second external electronic device according to an example may receive data via short-range wireless communication;

FIG. 3 is a block diagram of an electronic device according to an example;

FIG. 4A, FIG. 4B, and FIG. 4C are diagrams illustrating data traffic of a second external electronic device according to an example;

FIG. 5 is a diagram illustrating power consumed by a second external electronic device according to an example while performing short-range wireless communication; and

FIG. 6 is a flowchart illustrating an operation method of an electronic device according to an example.

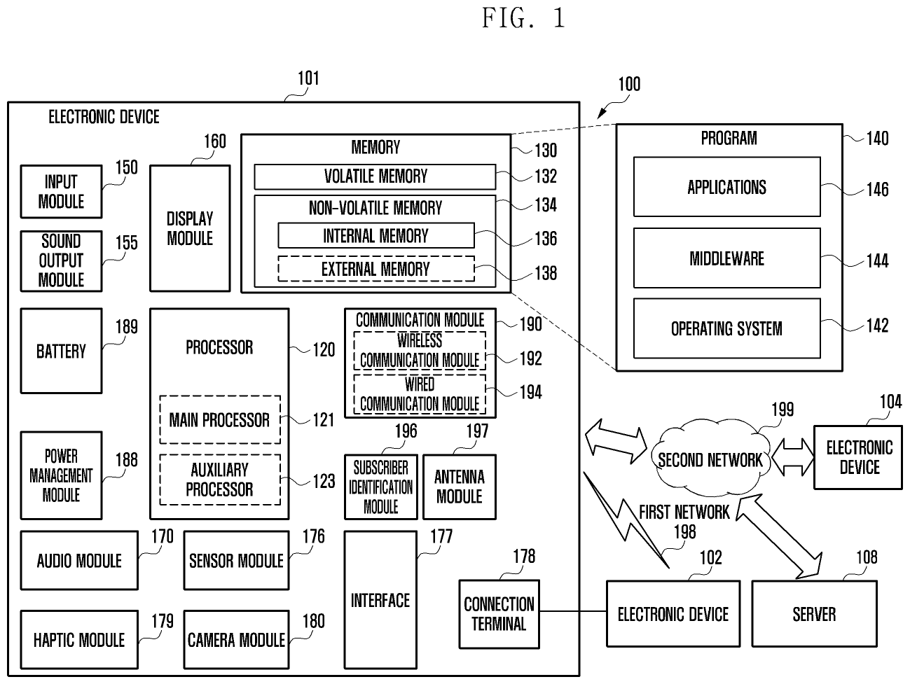

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

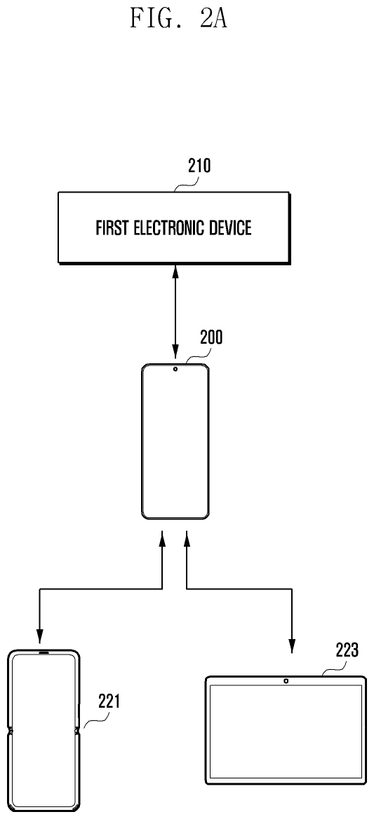

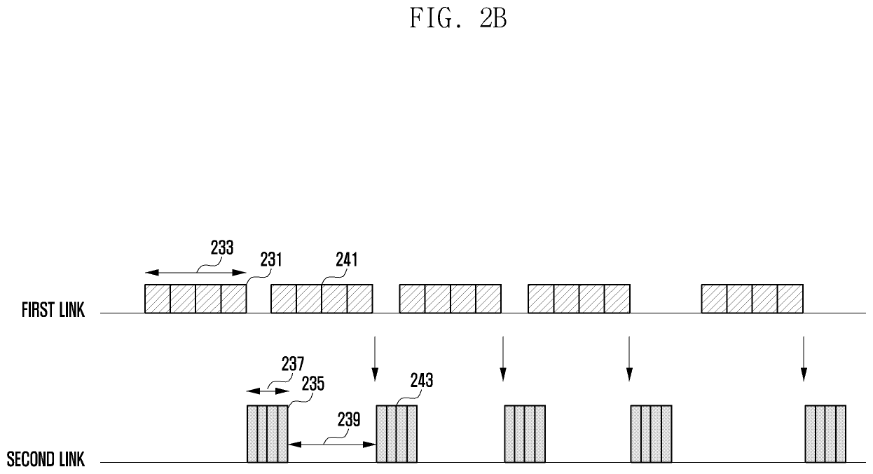

FIG. 2A is a diagram illustrating an electronic device, a first external electronic device, and a second external electronic device according to an example.

An electronic device 200 (e.g., the electronic device 101 of FIG. 1) may be connected to a first external electronic device 210 that provides a connection to a data network. The first external electronic device 210 may be an entity that provides a connection to the data network. According to an example, when the first external electronic device 210 supports short-range wireless communication, the first external electronic device 210 may perform the role of an access point (AP) defined in IEEE 802.11. According to an example, when the first external electronic device 210 supports cellular wireless communication, the first external electronic device 210 may perform the role of a base station or a node included in a cellular network. The first external electronic device 210 may transmit data transmitted by the data network to the electronic device 200, and may transmit data transmitted by the electronic device 200 to the data network.

A wireless channel established or generated between the electronic device 200 and the first external electronic device 210 may be referred to as a first link. The characteristics (e.g., a frequency band and a bandwidth) of the first link may be configured based on the performance of the electronic device 200 and the performance of the first external electronic device 210.

The electronic device 200 may be connected to a second external electronic device 221 or 223 connected to the electronic device 200. A wireless channel established or generated between the electronic device 200 and the second external electronic device 221 or 223 may be referred to as a second link. The characteristics (e.g., a frequency band and a bandwidth) of the second link may be configured based on the performance of the electronic device 200 and the performance of the second external electronic device 221 or 223.

The electronic device 200 may support a function that enables the second external electronic device 221 or 223 to perform a connection to the data network through the electronic device 200 (e.g., a mobile hotspot). The electronic device 200 may transmit data transmitted by the data network to the second external electronic device 221 or 223 through the first link and the second link as the function that enables the second external electronic device 221 or 223 to perform a connection to the data network through the electronic device 200 is activated. Alternatively, the electronic device 200 may transmit data transmitted by the second external electronic device 221 or 223 to the data network through the second link and the first link.

A bandwidth of the first link and a bandwidth of the second link may be different from each other. According to an example, if the first external electronic device 210 may be connected to the data network through a line that supports up to 100 Mbps, and the second external electronic device 221 or 223 and the electronic device 200 are connected through a wireless link having a performance of 2.4 Gbps, the bandwidth of the first link may be smaller than the bandwidth of the second link.

In a situation where the bandwidth of the first link is smaller than the bandwidth of the second link, the second external electronic device 221 or 223 may receive data through the electronic device 200, the second external electronic device 221 or 223 may wait to receive data while the electronic device 200 receives the data from the data network through the first external electronic device 210. The greater the difference between the bandwidth of the first link and the bandwidth of the second link, the longer a waiting time for reception of data may become. As the waiting time increases, unnecessary power consumption during the waiting time may increase. One specific example of the above is described later in FIG. 2B.

FIG. 2B is a diagram illustrating that a second external electronic device according to an example may receive data, for example, via short-range wireless communication.

Referring to FIG. 2B, an electronic device (e.g., the electronic device 210 of FIG. 2A) may receive data from a data network through a first link, and the electronic device 210 transmits data received through a second link to a second external electronic device (e.g., the second external electronic device 221 or 223 of FIG. 2A).

A bandwidth of the first link and a bandwidth of the second link may be different from each other. According to an example, if the first external electronic device 210 is connected to the data network through a line that supports up to 100 Mbps, and the second external electronic device 221 or 223 and the electronic device 200 are connected through a wireless link having a performance of 2.4 Gbps, the bandwidth of the first link may be smaller than the bandwidth of the second link.

In a situation where the bandwidth of the first link is smaller than the bandwidth of the second link, the electronic device 200 may receive data 231 from the data network through the first link during a first time 233. The electronic device 200 may transmit data 235 to the second external electronic device 221 or 223 through the second link during a second time 237 after completing the reception of the data 231.

When the bandwidth of the first link is smaller than the bandwidth of the second link, the second time 237 may be smaller than the first time 233. When the second time 237 is smaller than the first time 233, the second external electronic device 221 or 223 may wait to receive data during a specified time 239. The second external electronic device 221 or 223 may maintain a communication circuit (e.g., the wireless communication module 192 of FIG. 1) in an active state to wait to receive data during the specified time 239. While the second external electronic device 221 or 223 may wait to receive data during the specified time 239, the electronic device 210 may receive other data 241 from the data network through the first link. The electronic device 210 may transmit data 243 to the second external electronic device 221 or 223 through the second link as the reception of the data 241 is completed.

An active state of the communication circuit 192 may cause unnecessary power consumption (or standby power consumption). For example, an increase in a waiting time of the second external electronic device 221 or 223 may further increase the size of unnecessary power consumption.

The electronic device 200 may reduce the bandwidth of the second link in order to prevent or reduce unnecessary power consumption when the bandwidth of the first link is smaller than the bandwidth of the second link. However, when traffic of data transmitted and/or received by the second external electronic device 221 or 223 satisfies a specific condition, the reduction in the bandwidth of the second link may instead increase power consumption. When the bandwidth of the second link is reduced, a time required to transmit and/or receive data through the second link may increase. While transmitting and/or receiving data through the second link, the second external electronic device 221 or 223 and the electronic device 200 are required to maintain components (or parts) (e.g., the communication circuit 192) for transmitting and/or receiving data in an active state. An increase in the time required to transmit and/or receive data through the second link may increase a time of maintaining the active state of the components for transmitting and/or receiving data, which may increase power consumption.

In addition, when a waiting time 239 during which the second external electronic device 221 or 223 waits to receive data is longer than a time (e.g., return to sleep) during which the communication circuit 192 may switch to an idle state (or sleep state), the communication circuit 192 may switch to the idle state, thereby reducing standby power. In the case of reducing the bandwidth of the second link, a situation where a reduction in power consumption is prevented may occur since the waiting time 239 becomes shorter than the time (e.g., return to sleep) during which the communication circuit 192 may switch to the idle state.

Hereinafter, an example is described in which, when the bandwidth of the first link is smaller than the bandwidth of the second link, the electronic device 200 adjusts the bandwidth of the second link, based on whether the traffic of the data transmitted and/or received by the second external electronic device 221 or 223 satisfies a designated condition.

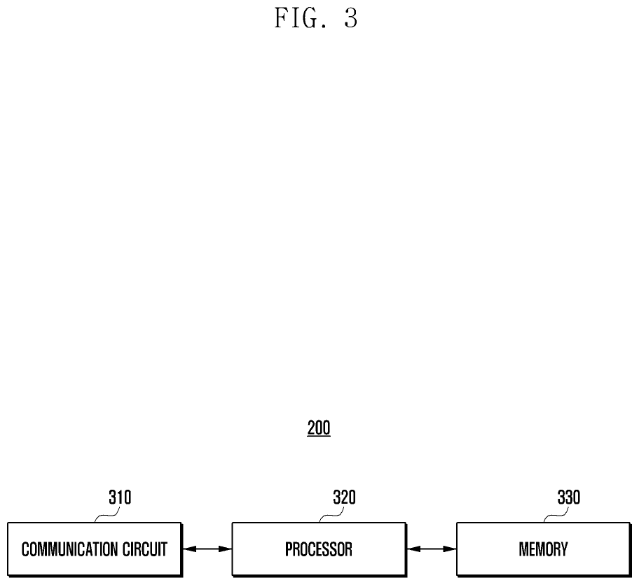

FIG. 3 is a block diagram of an electronic device according to an example.

An electronic device (e.g., the electronic device 200 of FIG. 2A) may include a communication module 310 (e.g., the communication module 192 of FIG. 1), a processor 320 (e.g., the processor 120 of FIG. 1), and a memory 330.

The communication circuit 310 may include various circuit structures used for modulating and/or demodulating a signal within the electronic device 200. For example, the communication circuit 310 may modulate a signal of a baseband into a signal of a radio frequency (RF) band so as to be output through an antenna (not shown), or demodulate a signal of an RF band received through the antenna into a signal of a baseband to transmit the signal to the processor 320.

The communication circuit 310 may transmit multiple packets to at least one second external electronic device (e.g., the second external electronic device 221 or 223 of FIG. 2A), for example, via short-range wireless communication, or may receive data transmitted by the second external electronic device 221 or 223.

The processor 320 may be operatively connected to the communication circuit 310 to control an operation of the communication circuit 310. The processor 320 may control the communication circuit 310 to transmit or receive a packet corresponding to the data. The data may be data related to a service running on the electronic device 200. For example, when a video call service is running on the electronic device 200, the data may be data (e.g., voice data and video data) related to the video call service.

The memory 330 may store instructions that may be executed by the processor 320. An operation of the processor 320 described below may be performed according to execution of the instructions stored on the memory 330.

The processor 320 may receive data transmitted by a data network through a first link established between the electronic device 200 and a first external electronic device (e.g., the first external electronic device 210 of FIG. 2A), and may transmit the data to the data network.

According to an example, when the first external electronic device 210 performs the role of a base station or a node included in a cellular network, the processor 320 may transmit and/or receive data through a resource allocated by the cellular network in a process of connecting to the cellular network through the first external electronic device 210. The characteristics (e.g., a frequency band or a bandwidth of the first link) of the first link may be determined by the cellular network, and the processor 320 may identify the characteristics of the first link, based on the characteristics of the first link transmitted by the cellular network.

The processor 320 may support a function (e.g., a mobile hotspot) that enables the second external electronic device 221 or 223 to perform a connection to the data network through the electronic device 200. The processor 320 may establish (or generate) a second link between the electronic device 200 and the second external electronic device 221 or 223 as the function (e.g., a mobile hotspot) that enables the second external electronic device 221 or 223 to perform a connection to the data network through the electronic device 200 is activated. As the establishment of the second link is completed, the processor 320 may control the communication circuit 310 to transmit the data transmitted by the data network to the second external electronic device 221 or 223 through the first link and the second link. Alternatively, the processor 320 may control the communication circuit 310 to transmit data transmitted by the second external electronic device 221 or 223 to the data network through the second link and the first link.

A bandwidth of the first link and a bandwidth of the second link may be different from each other. According to an example, if the first external electronic device 210 is connected to the data network through a line that supports up to 100 Mbps, and the second external electronic device 221 or 223 and the electronic device 200 are connected through a wireless link having a performance of 2.4 Gbps, the bandwidth of the first link may be smaller than the bandwidth of the second link.

In a situation where the bandwidth of the first link is smaller than the bandwidth of the second link, the second external electronic device 221 or 223 receives data through the electronic device 200, the second external electronic device 221 or 223 may wait to receive data while the electronic device 200 receives the data from the data network through the first external electronic device 210. The greater the difference between the bandwidth of the first link and the bandwidth of the second link, the longer a waiting time for reception of data may become. As the waiting time increases, unnecessary power consumption during the waiting time may increase. The processor 320 may perform a series of operations of adjusting the bandwidth of the second link in order to reduce unnecessary power consumption during the waiting time. Hereinafter, a specific example in which the processor 320 adjusts the bandwidth of the second link, based on traffic of data transmitted and/or received by the second external electronic device 221 or 223 is described.

The processor 320 may identify the bandwidth of the first link established between the electronic device 200 and the first external electronic device 210 and/or the bandwidth of the second link established between the electronic device 200 and the second external electronic device 221 or 223.

The processor 320 may, when connected to the first external electronic device 210, for example, via short-range wireless communication, identify the bandwidth of the first link by referring to information indicating a bandwidth included in an operating mode field included in an operating mode notification frame transmitted by the first external electronic device 210. Alternatively, the processor 320 may identify the bandwidth of the first link by referring to information indicating a bandwidth included in an operating mode control sub-field included in a quality of service (QoS) data frame.

The processor 320 may identify the bandwidth of the first link by referring to an information element included in a frame (e.g., an association request frame or an association response frame) exchanged in a process of establishing a connection with the first external electronic device 210, for example, via short-range wireless communication. According to an example, the information element may include a capabilities field or an operation field of a version (for example, high throughput (HT) (or Wi-Fi 4), very high throughput (VHT) (or Wi-Fi 5), high efficiency (HE) (or Wi-Fi 6), or extreme high efficiency (EHT) (or Wi-Fi 7)) of short-range wireless communication that the electronic device 200 and/or the first external electronic device 210 may support. The capabilities field or the operation field may include information indicating a pre-selected bandwidth. The processor 320 may identify the bandwidth of the first link by referring to the information indicating the bandwidth included in the capabilities field or the operation field.

The processor 320 may, when connected to the first external electronic device 210 via cellular wireless communication, identify the bandwidth of the first link by referring to information indicating a resource allocated by the first external electronic device 210 (or cellular network).

The processor 320 may, when connected to the second external electronic device 221 or 223, for example, via short-range wireless communication, identify the bandwidth of the second link by referring to information indicating a bandwidth included in an operating mode field included in an operating mode notification frame transmitted by the second external electronic device 221 or 223. Alternatively, the processor 320 may identify the bandwidth of the second link by referring to information indicating a bandwidth included in an operating mode control sub-field included in a quality of service (QOS) data frame.

The processor 320 may identify the bandwidth of the second link by referring to an information element included in a frame (e.g., an association request frame or an association response frame) exchanged in a process of establishing a connection with the second external electronic device 221 or 223, for example, via short-range wireless communication. According to an example, the information element may include a capabilities field or an operation field of a version (for example, high throughput (HT) (or Wi-Fi 4), very high throughput (VHT) (or Wi-Fi 5), high efficiency (HE) (or Wi-Fi 6), or extreme high efficiency (EHT) (or Wi-Fi 7)) of short-range wireless communication that the electronic device 200 and/or the second external electronic device 221 or 223 may support. The capabilities field or the operation field may include information indicating a pre-selected bandwidth. The processor 320 may identify the bandwidth of the second link by referring to the information indicating the bandwidth included in the capabilities field or the operation field.

The processor 320 may compare the bandwidth of the first link and the bandwidth of the second link. The processor 320 may identify whether the bandwidth of the second link is larger than the bandwidth of the first link.

According to an example, the bandwidth of the first link and/or the bandwidth of the second link may be one of 20 MHz, 40 MHz, 80 MHz, 160 MHz, and 320 MHz. When the bandwidth of the second link is at least twice the bandwidth of the first link, the processor 320 may determine that the bandwidth of the second link is larger than the bandwidth of the first link.

When it is identified that the bandwidth of the second link is larger than the bandwidth of the first link, the processor 320 may identify traffic of data transmitted and/or received by the second external electronic device 221 or 223. The traffic of the data may include a pattern of the data transmitted and/or received. The pattern of the data may include the size (or amount) of the data transmitted and/or received, the length of a time during which the data is transmitted and/or received, and a time difference between completion of the transmission and/or reception and transmission and/or reception of the next data.

The processor 320 may identify whether the traffic of the data satisfies a designated condition.

The designated condition may include a condition related to reducing the bandwidth of the second link. The designated condition may include a condition that can reduce power consumption (or power consumed while waiting for data transmission and/or reception) of the second external electronic device 221 or 223 in the case of reducing the bandwidth of the second link.

According to an example, the designated condition may include a condition for transmitting and/or receiving data equal to or larger than a specified size. The specified size may refer to a size of data having a relatively large capacity.

In the case of transmitting and/or receiving the data equal to or larger than the specified size, a time (or waiting time) from completion of the transmission and/or reception of the data until the start of transmission and/or reception of the next data may be shorter than a time (e.g., return to sleep) during which a communication circuit (e.g., the wireless communication module 192 of FIG. 1) of the second external electronic device 221 or 223 may switch to an idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

In the case of transmitting and/or receiving data equal to or smaller than (or below) the specified size, a time (or waiting time) from completion of the transmission and/or reception of the data until the start of transmission and/or reception of the next data may be longer than the time (e.g., return to sleep) during which the communication circuit (e.g., the wireless communication module 192 of FIG. 1) of the second external electronic device 221 or 223 may switch to the idle state. When the waiting time is longer than the time (e.g., return to sleep) during which the communication circuit (e.g., the wireless communication module 192 of FIG. 1) of the second external electronic device 221 or 223 may switch to the idle state, not reducing the bandwidth of the second link may reduce power consumption of the second external electronic device 221 or 223 compared to reducing the bandwidth of the second link.

According to an example, the designated condition may include a condition for transmitting and/or receiving data related to a service (e.g., a voice call service and a video call service) requiring low latency. In the case of transmitting and/or receiving the data related to the service requiring low latency, a time (or waiting time) at which transmission and/or reception of the next data begins after the transmission and/or reception of the data is completed may be shorter than the time (e.g., return to sleep) during which the communication circuit (e.g., the wireless communication module 192 of FIG. 1) of the second external electronic device 221 or 223 may switch to the idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

According to an example, the designated condition may include a condition in which a time (or waiting time) during which data is not transmitted and/or received is equal to or shorter than (or below) a specified length. The specified length may be a value related to a power saving mode of the communication circuit 192 of the second external electronic device 221 or 223. According to an example, the specified length may include the time (e.g., return to sleep) during which the communication circuit (e.g., the wireless communication module 192 of FIG. 1) of the second external electronic device 221 or 223 may switch to the idle state.

When the time (or waiting time) during which the data is not transmitted and/or received is equal to or shorter than (or below) the specified length, a time (or waiting time) at which transmission and/or reception of the next data begins after the transmission and/or reception of the data is completed may be shorter than the time (e.g., return to sleep) during which the communication circuit (e.g., the wireless communication module 192 of FIG. 1) of the second external electronic device 221 or 223 may switch to the idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

The processor 320 may directly analyze the traffic of the data transmitted and/or received by the second external electronic device 221 or 223. The processor 320 may connect an entity (e.g., extended Berkeley packet filter (eBPF)) capable of analyzing the traffic of the data to a transmission path (e.g., a TCP/IP layer) of the data transmitted and/or received by the second external electronic device 221 or 223, and analyze the traffic of the data.

Alternatively, the processor 320 may receive an analysis result of the traffic of the data transmitted and/or received by the second external electronic device 221 or 223 from the second external electronic device 221 or 223.

The processor 320 may perform a series of operations of reducing the bandwidth of the second link when the traffic of the data transmitted and/or received by the second external electronic device 221 or 223 satisfies the designated condition.

The processor 320 may control the communication circuit 310 to transmit information indicating a size of a reduced bandwidth of the second link to the second external electronic device 221 or 223. The size of the reduced bandwidth of the second link may be larger than a size of the bandwidth of the first link. Alternatively, the size of the reduced bandwidth of the second link may be the same as the size of the bandwidth of the first link.

The processor 320 may include the information indicating the size of the reduced bandwidth of the second link in an operating mode field included in an operating mode notification frame. The processor 320 may control the communication circuit 310 to transmit the operating mode notification frame including the information indicating the size of the reduced bandwidth of the second link to the second external electronic device 221 or 223.

Alternatively, the processor 320 may include the information indicating the size of the reduced bandwidth of the second link in an operating mode control sub-field included in a quality of service (QOS) data frame. The processor 320 may control the communication circuit 310 to transmit the QoS data frame including the information indicating the size of the reduced bandwidth of the second link to the second external electronic device 221 or 223.

Alternatively, the processor 320 may control the communication circuit 310 to transmit an action frame including the information indicating the size of the reduced bandwidth of the second link to the second external electronic device 221 or 223.

Alternatively, the processor 320 may control the communication circuit 310 to transmit a separate frame (e.g., an information element (vendor specific information element (VSIE) available to a manufacturer) including the information indicating the reduced bandwidth of the second link to the second external electronic device 221 or 223.

The processor 320 may reduce the bandwidth of the second link as the second external electronic device 221 or 223 identifies (or detects) that the bandwidth of the second link is reduced.

According to an example, the processor 320 may, when connected to the second external electronic device 221 or 223, for example, via short-range wireless communication, identify whether the bandwidth of the second link has been reduced, by referring to the information indicating the bandwidth included in the operating mode field included in the operating mode notification frame transmitted by the second external electronic device 221 or 223. Alternatively, the processor 320 may identify whether the bandwidth of the second link has been reduced, by referring to the information indicating the bandwidth included in the operating mode control sub-field included in the quality of service (QOS) data frame.

The processor 320 may reduce the bandwidth of the second link when all of the second external electronic devices 221 and 223 connected to the electronic device 200 through the second link have reduced the bandwidth of the second link.

The processor 320 may maintain the bandwidth of the second link when the traffic of the data transmitted and/or received by the second external electronic device 221 or 223 does not satisfy the designated condition. When the traffic of the data does not satisfy the designated condition, maintaining the bandwidth of the second link may reduce standby power of the second external electronic devices 221 or 223.

The processor 320 may identify whether the traffic of the data transmitted and/or received by the second external electronic device 221 or 223 satisfies the designated condition in a state where the bandwidth of the second link is reduced. The processor 320 may increase the bandwidth of the second link when the traffic of the data does not satisfy the designated condition. The increased bandwidth of the second link may be the same as the bandwidth of the second link before the bandwidth of the second link is reduced.

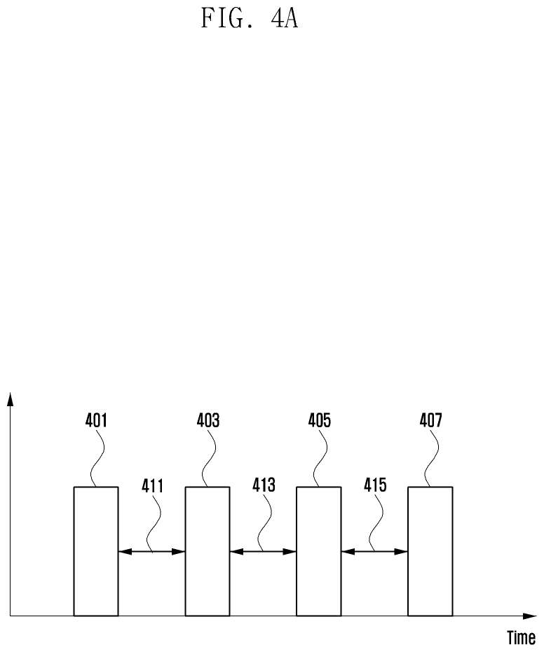

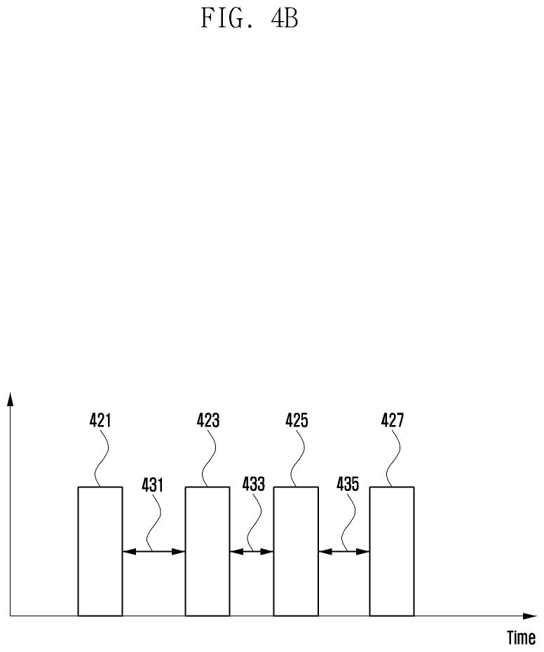

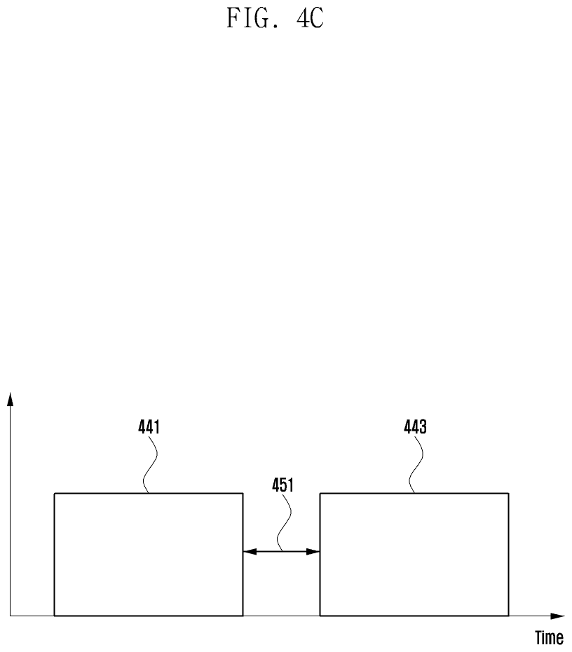

FIG. 4A, FIG. 4B, and FIG. 4C are diagrams illustrating data traffic of a second external electronic device according to an example.

FIG. 4A is a diagram illustrating data traffic in which data related to a service (e.g., a voice call service or a video call service) requiring low latency is transmitted and/or received.

A second external electronic device (e.g., the second external electronic device 221 or 223 of FIG. 2A) may transmit and/or receive data 401, 403, 405, and 407 related to a service requiring low latency to a data network through an electronic device (e.g., the electronic device 200 of FIG. 3) and a first external electronic device (e.g., the first external electronic device 210 of FIG. 2A).

In the case of transmitting and/or receiving data related to a service requiring low latency, times (or waiting times) 411, 413, and 415 at which transmission and/or reception of the next data begins after the transmission and/or reception of the data is completed may be shorter than a time (e.g., return to sleep) during which a communication circuit (e.g., the wireless communication module 192 of FIG. 1) of the second external electronic device 221 or 223 may switch to an idle state.

When the waiting times are shorter than the time (e.g., return to sleep) during which the communication circuit (e.g., the wireless communication module 192 of FIG. 1) of the second external electronic device 221 or 223 may switch to the idle state, reducing a bandwidth of a second link may reduce power consumption of the second external electronic device 221 or 223.

When data having a pattern as shown in FIG. 4A is transmitted and/or received, the electronic device 200 may determine that traffic of the data satisfies a designated condition.

FIG. 4B is a diagram illustrating data traffic in which a time (or waiting time) during which data is not transmitted and/or received is equal to or shorter than (or below) a specified length.

The second external electronic device 221 or 223 may transmit and/or receive data 421, 423, 425, and 427 for which times (or waiting times) 431, 433, and 435 during which data is not transmitted and/or received are equal to or shorter than (or below) a specified length to a data network through an electronic device (e.g., the electronic device 200 of FIG. 3) and a first external electronic device (e.g., the first external electronic device 210 of FIG. 2A).

The specified length may be a value related to a power saving mode of the communication circuit 192 of the second external electronic device 221 or 223. According to an example, the specified length may include a time (e.g., return to sleep) during which a communication circuit (e.g., the wireless communication module 192 of FIG. 1) of the second external electronic device 221 or 223 may switch to an idle state.

When the times (or waiting times) 431, 433, and 435 during which the data 421, 423, 425 and 427 are not transmitted and/or received are equal to or shorter than (or below) the specified length, times (or waiting times) at which transmission and/or reception of the next data begins after the transmission and/or reception of the data is completed may be shorter than the time (e.g., return to sleep) during which the communication circuit (e.g., the wireless communication module 192 of FIG. 1) of the second external electronic device 221 or 223 may switch to the idle state. When the waiting times 431, 433 and 435 are shorter than the time (e.g., return to sleep) during which the communication circuit (e.g., the wireless communication module 192 of FIG. 1) of the second external electronic device 221 or 223 may switch to the idle state, reducing a bandwidth of a second link may reduce power consumption of the second external electronic device 221 or 223.

When data having a pattern as shown in FIG. 4B is transmitted and/or received, the electronic device 200 may determine that traffic of the data satisfies a designated condition.

FIG. 4C is a diagram illustrating data traffic for transmitting and/or receiving data equal to or larger than a specified size.

The second external electronic device 221 or 223 may transmit and/or receive data 441 and 443 equal to or larger than a specified size to a data network through an electronic device (e.g., the electronic device 200 of FIG. 3) and a first external electronic device (e.g., the first external electronic device 210 of FIG. 2A).

In the case of transmitting and/or receiving the data 441 and 443 equal to or larger than the specified size, a time (or waiting time) 451 from completion of the transmission and/or reception of the data until the start of transmission and/or reception of the next data may be shorter than a time (e.g., return to sleep) during which a communication circuit (e.g., the wireless communication module 192 of FIG. 1) of the second external electronic device 221 or 223 may switch to an idle state. When the waiting time 451 is shorter than the time (e.g., return to sleep) during which the communication circuit (e.g., the wireless communication module 192 of FIG. 1) of the second external electronic device 221 or 223 may switch to the idle state, reducing a bandwidth of a second link may reduce power consumption of the second external electronic device 221 or 223.

When data having a pattern as shown in FIG. 4C is transmitted and/or received, the electronic device 200 may determine that traffic of the data satisfies a designated condition.

The electronic device 200 may perform a series of operations of reducing the bandwidth of the second link when the traffic of the data transmitted and/or received by the second external electronic device 221 or 223 satisfies the designated condition.

The electronic device 200 may control the communication circuit 310 to transmit information indicating a size of a reduced bandwidth of the second link to the second external electronic device 221 or 223. The size of the reduced bandwidth of the second link may be larger than a size of a bandwidth of a first link. Alternatively, the size of the reduced bandwidth of the second link may be the same as the size of the bandwidth of the first link.

The electronic device 200 may include the information indicating the size of the reduced bandwidth of the second link in an operating mode field included in an operating mode notification frame. The processor 320 may control the communication circuit 310 to transmit the operating mode notification frame including the information indicating the size of the reduced bandwidth of the second link to the second external electronic device 221 or 223.

Alternatively, the electronic device 200 may include the information indicating the size of the reduced bandwidth of the second link in an operating mode control sub-field included in a quality of service (QOS) data frame. The electronic device 200 may control the communication circuit 310 to transmit the QoS data frame including the information indicating the size of the reduced bandwidth of the second link to the second external electronic device 221 or 223.

The electronic device 200 may reduce the bandwidth of the second link as the second external electronic device 221 or 223 identifies (or detects) that the bandwidth of the second link is reduced.

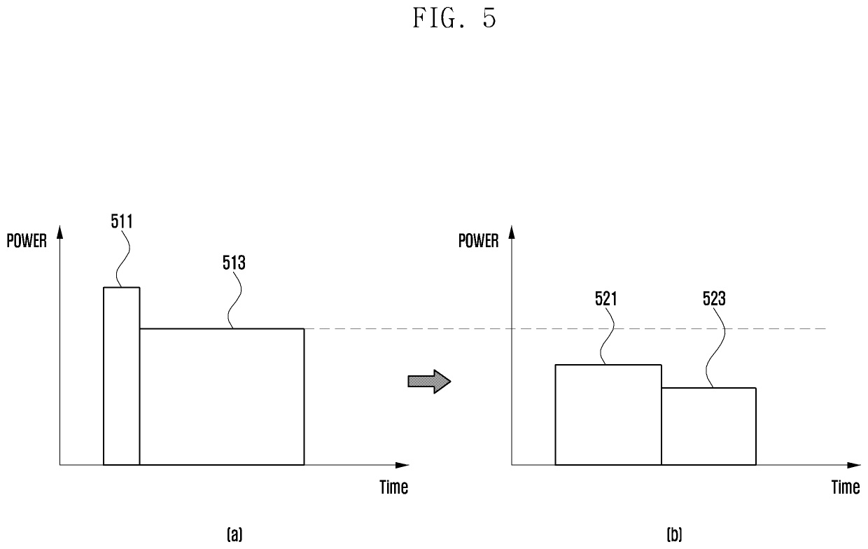

FIG. 5 is a diagram illustrating power consumed by a second external electronic device according to an example while performing short-range wireless communication.

Part (a) of FIG. 5 corresponds to a diagram illustrating power consumed by a second external electronic device (e.g., the second external electronic device 221 or 223 of FIG. 2A) while transmitting and/or receiving data through a second link before reducing a bandwidth.

Referring to part (a) of FIG. 5, the second external electronic device 221 or 223 may consume a first power 511 according to transmission and/or reception of data, and after the transmission and/or reception of the data is completed, consume a second power 513 while waiting for transmission and/or reception of the next data.

Part (b) of FIG. 5 corresponds to a diagram illustrating power consumed by the second external electronic device 221 or 223 while transmitting and/or receiving data through a second link after reducing a bandwidth.

Referring to part (b) of FIG. 5, the second external electronic device 221 or 223 may consume a third power 521 according to transmission and/or reception of data, and after the transmission and/or reception of the data is completed, consume a fourth power 523 while waiting for transmission and/or reception of the next data.

For convenience of description, it is assumed that the sum of a time during which the first power 511 is consumed and a time during which the second power 513 is consumed is substantially equal to the sum of a time during which the third power 521 is consumed and a time during which the fourth power 523 is consumed.

The sum of the first power 511 and the second power 513 may be greater than the sum of the third power 521 and the fourth power 523, and the above situation may refer to a reduction in power consumed by the second external electronic device 221 or 223 due to a reduction in a bandwidth of the second link. The reduction in the power consumed by the second external electronic device 221 or 223 may refer to a case where, even when the bandwidth of the second link is reduced, the sum of a time required for data transmission and/or reception through the second link and a time waiting for data transmission and/or reception through the second link is not significantly different from the sum of a time required for data transmission and/or reception through the second link and a time waiting for data transmission and/or reception through the second link when the bandwidth of the second link is maintained. When the difference in the sums of the times is not significant, transmitting and/or receiving data using a relatively smaller bandwidth may reduce power consumption.

The electronic device 200 according to the disclosure may reduce the bandwidth of the second link when a bandwidth of a first link is smaller than the bandwidth of the second link and traffic of data transmitted and/or received by the second external electronic device 221 or 223 satisfies a designated condition, and thus reduce power consumed by the second external electronic device 221 or 223. In addition, as the bandwidth of the second link is reduced, the speed of data transmission and/or reception through the second link may be reduced, but due to limitation of the bandwidth of the first link, the speed of data transmission and/or reception through the second link is relatively reduced less. Accordingly, the electronic device 200 may reduce the bandwidth of the second link in a situation where the speed of data transmission and/or reception through the second link is relatively less reduced even when the bandwidth of the second link is reduced, and thus reduce the power consumed by the second external electronic device 221 or 223.

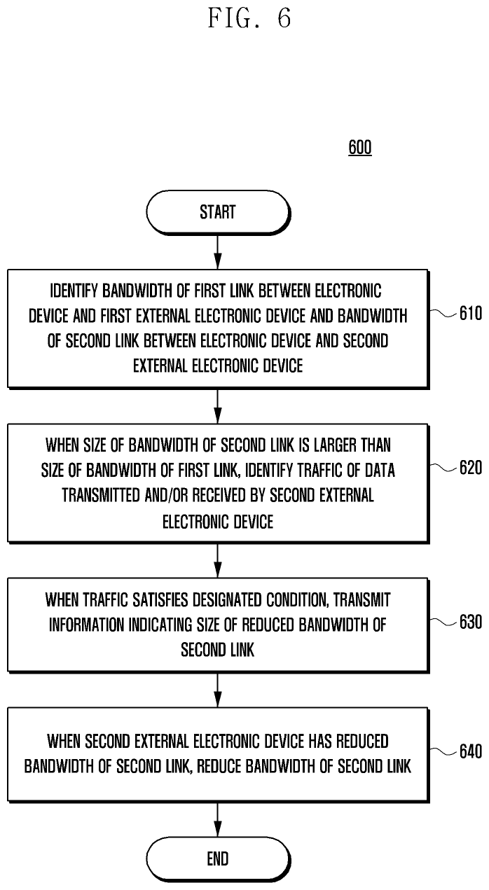

FIG. 6 is a flowchart illustrating an operation method 600 of an electronic device according to an example.

In operation 610, an electronic device (e.g., the electronic device 200 of FIG. 3) may identify a bandwidth of a first link between the electronic device 200 and a first external electronic device (e.g., the first external electronic device 210 of FIG. 2A) and a bandwidth of a second link between the electronic device 200 and a second external electronic device (e.g., the second external electronic device 221 or 223 of FIG. 2A).

The electronic device 200 may receive data transmitted by a data network through the first link established between the electronic device 200 and the first external electronic device (e.g., the first external electronic device 210 of FIG. 2A), and transmit the data to the data network.

The electronic device 200 may support a function (e.g., a mobile hotspot) that enables the second external electronic device 221 or 223 to perform a connection to the data network through the electronic device 200. The electronic device 200 may establish (or generate) the second link between the electronic device 200 and the second external electronic device 221 or 223 as the function (e.g., a mobile hotspot) that enables the second external electronic device 221 or 223 to perform a connection to the data network through the electronic device 200 is activated. As the establishment of the second link is completed, the electronic device 200 may control the communication circuit 310 to transmit the data transmitted by the data network to the second external electronic device 221 or 223 through the first link and the second link. Alternatively, the electronic device 200 may control the communication circuit 310 to transmit data transmitted by the second external electronic device 221 or 223 to the data network through the second link and the first link.

The bandwidth of the first link and the bandwidth of the second link may be different from each other. According to an example, if the first external electronic device 210 is connected to the data network through a line that supports up to 100 Mbps, and the second external electronic device 221 or 223 and the electronic device 200 are connected through a wireless link having a performance of 2.4 Gbps, the bandwidth of the first link may be smaller than the bandwidth of the second link.

The electronic device 200 may identify the bandwidth of the first link established between the electronic device 200 and the first external electronic device 210 and/or the bandwidth of the second link established between the electronic device 200 and the second external electronic device 221 or 223.

The electronic device 200 may, when connected to the first external electronic device 210, for example, via short-range wireless communication, identify the bandwidth of the first link by referring to information indicating a bandwidth included in an operating mode field included in an operating mode notification frame transmitted by the first external electronic device 210. Alternatively, the electronic device 200 may identify the bandwidth of the first link by referring to information indicating a bandwidth included in an operating mode control sub-field included in a quality of service (QOS) data frame.

The electronic device 200 may, when connected to the first external electronic device 210 via cellular wireless communication, identify the bandwidth of the first link by referring to information indicating a resource allocated by the first external electronic device 210 (or a cellular network).

The electronic device 200 may identify the bandwidth of the first link by referring to an information element included in a frame (e.g., an association request frame or an association response frame) exchanged in a process of establishing a connection with the first external electronic device 210, for example, via short-range wireless communication. According to an example, the information element may include a capabilities field or an operation field of a version (for example, high throughput (HT) (or Wi-Fi 4), very high throughput (VHT) (or Wi-Fi 5), high efficiency (HE) (or Wi-Fi 6), or extreme high efficiency (EHT) (or Wi-Fi 7)) of short-range wireless communication that the electronic device 200 and/or the first external electronic device 210 may support. The capabilities field or the operation field may include information indicating a pre-selected bandwidth. The electronic device 200 may identify the bandwidth of the first link by referring to the information indicating the bandwidth included in the capabilities field or the operation field.

The electronic device 200 may, when connected to the second external electronic device 221 or 223, for example, via short-range wireless communication, identify the bandwidth of the second link by referring to information indicating a bandwidth included in an operating mode field included in an operating mode notification frame transmitted by the second external electronic device 221 or 223. Alternatively, the electronic device 200 may identify the bandwidth of the second link by referring to information indicating a bandwidth included in an operating mode control sub-field included in a quality of service (QOS) data frame.

The electronic device 200 may identify the bandwidth of the second link by referring to an information element included in a frame (e.g., an association request frame or an association response frame) exchanged in a process of establishing a connection with the second external electronic device 221 or 223, for example, via short-range wireless communication. According to an example, the information element may include a capabilities field or an operation field of a version (for example, high throughput (HT) (or Wi-Fi 4), very high throughput (VHT) (or Wi-Fi 5), high efficiency (HE) (or Wi-Fi 6), or extreme high efficiency (EHT) (or Wi-Fi 7)) of short-range wireless communication that the electronic device 200 and/or the first external electronic device 210 may support. The capabilities field or the operation field may include information indicating a pre-selected bandwidth. The electronic device 200 may identify the bandwidth of the second link by referring to the information indicating the bandwidth included in the capabilities field or the operation field.

In operation 620, the electronic device 200 may identify traffic of data transmitted and/or received by the second external electronic device 221 or 223 when a size of the bandwidth of the second link is larger than a size of the bandwidth of the first link.

The electronic device 200 may compare the bandwidth of the first link and the bandwidth of the second link. The electronic device 200 may identify whether the bandwidth of the second link is larger than the bandwidth of the first link.

According to an example, the bandwidth of the first link and/or the bandwidth of the second link may be one of 20 MHz, 40 MHz, 80 MHz, 160 MHz, and 320 MHz. When the bandwidth of the second link is at least twice the bandwidth of the first link, the electronic device 200 may determine that the bandwidth of the second link is larger than the bandwidth of the first link.

When it is identified that the bandwidth of the second link is larger than the bandwidth of the first link, the electronic device 200 may identify the traffic of the data transmitted and/or received by the second external electronic device 221 or 223. The traffic of the data may include a pattern of the data transmitted and/or received. The pattern of the data may include the size (or amount) of the data transmitted and/or received, the length of a time during which the data is transmitted and/or received, and a time difference between completion of the transmission and/or reception and transmission and/or reception of the next data.

In operation 630, when the traffic satisfies a designated condition, the electronic device 200 may transmit information indicating a reduced bandwidth of the second link to the second external electronic device 221 or 223.

The electronic device 200 may identify whether the traffic of the data satisfies the designated condition.

The designated condition may include a condition related to reducing the bandwidth of the second link. The designated condition may include a condition that can reduce power consumption (or power consumed while waiting for data transmission and/or reception) of the second external electronic device 221 or 223 in the case of reducing the bandwidth of the second link.

According to an example, the designated condition may include a condition for transmitting and/or receiving data equal to or larger than a specified size. The specified size may refer to a size of data having a relatively large capacity.

In the case of transmitting and/or receiving the data equal to or larger than the specified size, a time (or waiting time) from completion of the transmission and/or reception of the data until the start of transmission and/or reception of the next data may be shorter than a time (e.g., return to sleep) during which a communication circuit (e.g., the wireless communication module 192 of

FIG. 1) of the second external electronic device 221 or 223 may switch to an idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

In the case of transmitting and/or receiving data equal to or smaller than (or below) the specified size, a time (or waiting time) from completion of the transmission and/or reception of the data until the start of transmission and/or reception of the next data may be longer than the time (e.g., return to sleep) during which the communication circuit (e.g., the wireless communication module 192 of FIG. 1) of the second external electronic device 221 or 223 may switch to the idle state. When the waiting time is longer than the time (e.g., return to sleep) during which the communication circuit (e.g., the wireless communication module 192 of FIG. 1) of the second external electronic device 221 or 223 may switch to the idle state, not reducing the bandwidth of the second link may reduce power consumption of the second external electronic device 221 or 223 compared to reducing the bandwidth of the second link.

According to an example, the designated condition may include a condition for transmitting and/or receiving data related to a service (e.g., a voice call service and a video call service) requiring low latency. In the case of transmitting and/or receiving the data related to the service requiring low latency, a time (or waiting time) at which transmission and/or reception of the next data begins after the transmission and/or reception of the data is completed may be shorter than the time (e.g., return to sleep) during which the communication circuit (e.g., the wireless communication module 192 of FIG. 1) of the second external electronic device 221 or 223 may switch to the idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

According to an example, the designated condition may include a condition in which a time (or waiting time) during which data is not transmitted and/or received is equal to or shorter than (or below) a specified length. The specified length may be a value related to a power saving mode of the communication circuit 192 of the second external electronic device 221 or 223. According to an example, the specified length may include the time (e.g., return to sleep) during which the communication circuit (e.g., the wireless communication module 192 of FIG. 1) of the second external electronic device 221 or 223 may switch to the idle state.

When the time (or waiting time) during which the data is not transmitted and/or received is equal to or shorter than (or below) the specified length, a time (or waiting time) at which transmission and/or reception of the next data begins after the transmission and/or reception of the data is completed may be shorter than the time (e.g., return to sleep) during which the communication circuit (e.g., the wireless communication module 192 of FIG. 1) of the second external electronic device 221 or 223 may switch to the idle state. When the waiting time is shorter than the time (e.g., return to sleep) during which the communication circuit (e.g., the wireless communication module 192 of FIG. 1) of the second external electronic device 221 or 223 may switch to the idle state, reducing the bandwidth of the second link may reduce power consumption of the second external electronic device 221 or 223.

The electronic device 200 may directly analyze the traffic of the data transmitted and/or received by the second external electronic device 221 or 223. The electronic device 200 may connect an entity (e.g., extended Berkeley packet filter (eBPF)) capable of analyzing the traffic of the data to a transmission path (e.g., a TCP/IP layer) of the data transmitted and/or received by the second external electronic device 221 or 223, and analyze the traffic of the data.

Alternatively, the electronic device 200 may receive an analysis result of the traffic of the data transmitted and/or received by the second external electronic device 221 or 223 from the second external electronic device 221 or 223.

The electronic device 200 may perform a series of operations of reducing the bandwidth of the second link when the traffic of the data transmitted and/or received by the second external electronic device 221 or 223 satisfies the designated condition.

The electronic device 200 may control the communication circuit 310 to transmit information indicating a size of the reduced bandwidth of the second link to the second external electronic device 221 or 223. The size of the reduced bandwidth of the second link may be larger than the size of the bandwidth of the first link. Alternatively, the size of the reduced bandwidth of the second link may be the same as the size of the bandwidth of the first link.

The electronic device 200 may include the information indicating the size of the reduced bandwidth of the second link in an operating mode field included in an operating mode notification frame. The electronic device 200 may control the communication circuit 310 to transmit the operating mode notification frame including the information indicating the size of the reduced bandwidth of the second link to the second external electronic device 221 or 223.

Alternatively, the electronic device 200 may include the information indicating the size of the reduced bandwidth of the second link in an operating mode control sub-field included in a quality of service (QoS) data frame. The electronic device 200 may control the communication circuit 310 to transmit the QoS data frame including the information indicating the size of the reduced bandwidth of the second link to the second external electronic device 221 or 223.

In operation 640, the electronic device 200 may reduce the bandwidth of the second link when the second external electronic device 221 or 223 has reduced the bandwidth of the second link.

According to an example, the electronic device 200 may, when connected to the second external electronic device 221 or 223, for example, via short-range wireless communication, identify whether the bandwidth of the second link has been reduced, by referring to the information indicating the bandwidth included in the operating mode field included in the operating mode notification frame transmitted by the second external electronic device 221 or 223. Alternatively, the electronic device 200 may identify whether the bandwidth of the second link has been reduced, by referring to the information indicating the bandwidth included in the operating mode control sub-field included in the quality of service (QoS) data frame.

The electronic device 200 may reduce the bandwidth of the second link when all of the second external electronic devices 221 and 223 connected to the electronic device 200 through the second link have reduced the bandwidth of the second link.

The electronic device 200 may identify whether the traffic of the data transmitted and/or received by the second external electronic device 221 or 223 satisfies the designated condition in a state where the bandwidth of the second link is reduced. The electronic device 200 may increase the bandwidth of the second link when the traffic of the data does not satisfy the designated condition. The increased bandwidth of the second link may be the same as the bandwidth of the second link before the bandwidth of the second link is reduced.

An electronic device according to an example may include a communication circuit connected to a first external electronic device configured to provide a connection to a data network. The electronic device may include a processor. The electronic device may include a memory. The memory may be configured to store instructions that, when executed by the processor, cause the electronic device to identify a bandwidth of a first link established between the electronic device and the first external electronic device and a bandwidth of a second link established between the electronic device and a second external electronic device configured to transmit and/or receive data to the data network through the electronic device. The memory may be configured to store instructions that, when executed by the processor, cause the electronic device to, in a case that a size of the bandwidth of the second link is larger than a size of the bandwidth of the first link, identify traffic of data transmitted and/or received by the second external electronic device. The memory may be configured to store instructions that, when executed by the processor, cause the electronic device to, in a case that the traffic satisfies a designated condition, control the communication circuit to transmit information indicating a size of a reduced bandwidth of the second link to the second external electronic device. The memory may be configured to store instructions that, when executed by the processor, cause the electronic device to, in a case that the second external electronic device has reduced the bandwidth of the second link, reduce the bandwidth of the second link.

In the electronic device according to an embodiment, the designated condition may include a condition for transmitting and/or receiving data equal to or larger than a specified size.

In the electronic device according to an embodiment, the designated condition may include a condition for transmitting and/or receiving data related to a service requiring low latency.

In the electronic device according to an embodiment, the designated condition may include a condition in which a time during which the data is not transmitted and/or received is shorter than a specified value.

In the electronic device according to an embodiment, the specified value may be a value related to a power saving mode of the communication circuit.

In the electronic device according to an embodiment, the size of the reduced bandwidth of the second link may be configured to be larger than the size of the bandwidth of the first link.

In the electronic device according to an embodiment, the memory may be configured to further store instructions that, when executed by the processor, cause the electronic device to control the communication circuit to transmit, to the second external electronic device, an operating mode field including the information indicating the size of the reduced bandwidth of the second link.

In the electronic device according to an embodiment, the memory may be configured to further store instructions that, when executed by the processor, cause the electronic device to, when the traffic does not satisfy the designated condition, maintain the size of the bandwidth of the second link.

In the electronic device according to an embodiment, the memory may be configured to further store instructions that, when executed by the processor, cause the electronic device to establish the second link according to activation of a mobile hotspot.

An operation method of an electronic device according to an embodiment may include identifying a bandwidth of a first link established between the electronic device and a first external electronic device configured to provide a connection to a data network and a bandwidth of a second link established between the electronic device and a second external electronic device configured to transmit and/or receive data to the data network through the electronic device. The operation method of the electronic device may include, in a case that a size of the bandwidth of the second link is larger than a size of the bandwidth of the first link, identifying traffic of data transmitted and/or received by the second external electronic device. The operation method of the electronic device may include, in a case that the traffic satisfies a designated condition, transmitting information indicating a size of a reduced bandwidth of the second link to the second external electronic device. The operation method of the electronic device may include, in a case that the second external electronic device has reduced the bandwidth of the second link, reducing the bandwidth of the second link.

In the operation method of the electronic device according to an embodiment, the designated condition may include a condition for transmitting and/or receiving data equal to or larger than a specified size.

In the operation method of the electronic device according to an embodiment, the designated condition may include a condition for transmitting and/or receiving data related to a service requiring low latency.

In the operation method of the electronic device according to an embodiment, the designated condition may include a condition in which a time during which the data is not transmitted and/or received is shorter than a specified value.

In the operation method of the electronic device according to an embodiment, the specified value may be a value related to a power saving mode of communication circuit.

In the operation method of the electronic device according to an embodiment, the size of the reduced bandwidth of the second link may be configured to be larger than the size of the bandwidth of the first link.

In the operation method of the electronic device according to an embodiment, the transmitting of the information indicating the size of the reduced bandwidth of the second link may include transmitting, to the second external electronic device, an operating mode field including the information indicating the size of the reduced bandwidth of the second link.

The operation method of the electronic device according to an embodiment may further include, when the traffic does not satisfy the designated condition, maintaining the size of the bandwidth of the second link.

The operation method of the electronic device according to an embodiment may further include establishing the second link according to activation of a mobile hotspot.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication circuit operatively connected to a first external electronic device, wherein the first external electronic device is configured to provide a connection to a data network;
a processor operatively connected to the communication circuit; and
a memory operatively connected to the processor,
wherein the memory is configured to store instructions that, when executed by the processor, cause the electronic device to:
identify a bandwidth size of a first link established between the electronic device and the first external electronic device and a bandwidth size of a second link established between the electronic device and a second external electronic device, the second external electronic device configured to communicate data with the data network through the electronic device;
in a case that the bandwidth size of the second link is larger than the bandwidth size of the first link, identify data traffic communicated by the second external electronic device;
in a case that the data traffic satisfies a designated condition, control the communication circuit to transmit information indicating a reduced bandwidth size of the second link to the second external electronic device; and
in a case that the second external electronic device has reduced the bandwidth size of the second link, reduce the bandwidth size of the second link.

2. The electronic device of claim 1, wherein the designated condition comprises a condition that the data traffic is equal to or larger than a specified amount.

3. The electronic device of claim 1, wherein the designated condition comprises a condition that the data traffic is associated with a service requiring low latency.

4. The electronic device of claim 1, wherein the designated condition comprises a condition in which a time during which data related to the data traffic is neither transmitted nor received is shorter than a specified value.

5. The electronic device of claim 4, wherein the specified value is associated with switching to a power saving mode of the communication circuit.

6. The electronic device of claim 1, wherein the reduced bandwidth size of the second link is configured to be larger than the bandwidth size of the first link.

7. The electronic device of claim 1, wherein the instructions, when executed by the processor, cause the electronic device to control the communication circuit to transmit, to the second external electronic device, an operating mode field comprising the information indicating the reduced bandwidth size of the second link.

8. The electronic device of claim 1, wherein the instructions, when executed by the processor in a case that the data traffic does not satisfy the designated condition, cause the electronic device to maintain the bandwidth size of the second link.

9. The electronic device of claim 1, wherein the instructions, when executed by the processor, cause the electronic device to establish the second link according to activation of a mobile hotspot.

10. An operation method of an electronic device, the method comprising:
identifying a bandwidth size of a first link established between the electronic device and a first external electronic device configured to provide a connection to a data network and a bandwidth size of a second link established between the electronic device and a second external electronic device configured to communicate data with the data network through the electronic device;
in a case that the bandwidth size of the second link is larger than the bandwidth size of the first link, identifying data traffic communicated by the second external electronic device;
in a case that the data traffic satisfies a designated condition, transmitting information indicating a reduced bandwidth size of the second link to the second external electronic device; and
in a case that the second external electronic device has reduced the bandwidth size of the second link, reducing the bandwidth size of the second link.

11. The operation method of claim 10, wherein the designated condition comprises a condition that the data traffic is equal to or larger than a specified amount.

12. The operation method of claim 10, wherein the designated condition comprises a condition that the data traffic is associated with a service requiring low latency.

13. The operation method of claim 10, wherein the designated condition comprises a condition in which a time during which data related to the data traffic is neither transmitted nor received is shorter than a specified value.

14. The operation method of claim 13, wherein the specified value is associated with switching to a power saving mode of a communication circuit.

15. The operation method of claim 10, wherein the reduced bandwidth size of the second link is configured to be larger than the bandwidth size of the first link.

16. The operation method of claim 10, wherein the transmitting of the information indicating the reduced bandwidth size of the second link comprises transmitting, to the second external electronic device, an operating mode field comprising the information indicating the reduced bandwidth size of the second link.

17. The operation method of claim 10, further comprising, in a case that the traffic does not satisfy the designated condition, maintaining the bandwidth size of the second link.

18. The operation method of claim 10, further comprising establishing the second link according to activation of a mobile hotspot.
